(19) United States
(12) Patent Application Publication
(10) Pub. No.: US 2025/0360433 A1
(43) Pub. Date: Nov. 27, 2025

(54) PREPARING METHOD OF SUBCRITICAL WATER EXTRACTION FROM ALMOND BY-PRODUCT

(71) Applicant: Blessed Project, Paju-si (KR)

(72) Inventor: Yeon Ju BAEK, Pyeongtaek-si (KR)

(21) Appl. No.: 18/907,642

(22) Filed: Oct. 7, 2024

(30) Foreign Application Priority Data
May 27, 2024 (KR) 10-2024-0068306

(51) Int. Cl. B01D 11/02

(52) U.S. Cl. CPC B01D 11/0203; B01D 2257/7027

(57) ABSTRACT

The present disclosure relates to a method for preparing a subcritical water extract of an almond by-product, and specifically, to a method for extracting polyphenols from almond hulls in high yield using subcritical water extraction. The present disclosure can effectively utilize almond hulls, which is an almond by-product generated during the production and harvest of almonds, and minimize the amount of almond waste, and is environmentally-friendly because polyphenols are extracted using only subcritical water. Additionally, the extraction yield of polyphenols within almond hulls can be improved by performing the extraction under specific conditions.

### TECHNICAL FIELD

The present disclosure relates to a method for preparing a subcritical water extract of an almond by-product, and specifically, to a method for extracting polyphenols from almond hulls in high yield using subcritical water extraction.

### BACKGROUND

In general, almonds are nuts that are known to be good for the skin as they are rich in unsaturated fatty acids and vitamin E. Recently, not only almonds but also almond by-products are being utilized in various ways.

Almond hulls, which are a type of almond by-product, have traditionally been used as a bedding for stocks and feed for animals. Since almond hulls are rich in carbohydrates and fiber, studies for the creation of added value of the same have been conducted. In particular, in order to minimize the discharge of almond waste and efficiently utilize almond hulls in an environmentally-friendly manner, active studies are being conducted to increase the extraction yield of physiologically active compounds within almond hulls.

For example, extraction methods using various solvents to extract polyphenols from almond hulls have been reported. The following results were reported: when almond hulls were extracted for 24 hours in a solvent containing equal ratios of ethanol and water, about 25 mg of gallic acid equivalent (GAE) of polyphenol was obtained per 1 g of dry weight of almond hulls, whereas when microwave-assisted extraction (MAE) was used, about 48 mg GAE of polyphenol was obtained per 1 g of dry weight of almond hulls (Salgado et al., 2022, Microwave heating for sustainable valorization of almond hull towards high-added-value chemicals). Additionally, there was also a report that when the extraction was performed for 6 hours in a solvent where acetone and water were mixed in a 70:30 ratio, about 81 mg GAE of polyphenol was obtained per 1 g of dry weight of almond hulls (Meshkini, A., 2016, Acetone extract of almond hulls provides protection against oxidative damage and membrane protein degradation).

Meanwhile, subcritical water refers to water at a high-temperature, high-pressure condition below the critical point of water (374° C., 22.1 MPa). Subcritical water extraction is a process of extracting useful components from a substance by utilizing the strong hydrolytic power and organic matter dissolving power of subcritical water. Since subcritical water extraction varies depending on temperature and pressure, useful components may be extracted through reduction of molecular weight by hydrolysis, thermal decomposition, and material transformation by oxidative decomposition. Subcritical water extraction has advantages in that the solvent used is water and that the time required for extraction is short, and the extraction is also advantageous in that the extraction yield can be improved.

In Korea, active studies have been reported regarding the extraction of flavonoids from apple pericarps, the extraction of active ingredients from ginseng, and the extraction of useful ingredients from mushrooms, seaweed, kombu, green laver, laver, etc. using subcritical water extraction, but no studies have yet been conducted regarding the application of subcritical water extraction to almond by-products.

Accordingly, the present inventors have confirmed that the extraction yield of polyphenols from almond hulls can be significantly excellent by using subcritical water extraction under specific conditions, thereby completing the present disclosure.

### PRIOR ART DOCUMENT

### Patent Document

Korean Patent No. 10-2282960

### SUMMARY

The object to solve in the present disclosure is to provide a method for producing a subcritical water extract of an almond by-product using a subcritical water extraction method under specific temperature and pressure conditions.

In order to solve the above object, the present disclosure provides a method for preparing a subcritical water extract of an almond by-product, which includes: grinding an almond by-product using a grinder; maintaining the induction time, which is the time required for the temperature of an oven inside a subcritical water extractor to become the same as the pre-set temperature of the subcritical water extractor; supplying the ground almond by-product to the subcritical water extractor; and supplying distilled water to the subcritical water extractor and performing subcritical water extraction at a temperature of 130° C. to 150° C. and a pressure of 8 MPa to 12 MPa.

The subcritical water extraction may be performed for 10 to 20 minutes.

The almond by-product may be almond hulls.

The ground almond by-product may have a particle size of 1.0 mm to 1.4 mm.

The subcritical water extract of the almond by-product may include polyphenols.

### Advantageous Effects

The method of the present disclosure can minimize the amount of almond waste by effectively utilizing almond hulls, which is an almond by-product generated during the production and harvest of almonds, and is environmentally-friendly because polyphenols are extracted using only subcritical water. Additionally, the extraction yield of polyphenols in almond hulls can be improved by performing the extraction under specific temperature, pressure, and time conditions.

### BRIEF DESCRIPTION OF THE DRAWINGS

FIG. 1 is a flow chart of a method for preparing a subcritical water extract of an almond by-product according to an example of the present disclosure.

FIG. 2 is a schematic diagram of a subcritical water extractor.

FIG. 3 shows the measurement results of the total polyphenol content in almond hulls according to extraction temperature and extraction time conditions.

### DETAILED DESCRIPTION OF EXEMPLARY EMBODIMENTS

In the present disclosure, it was confirmed that the extraction yield of polyphenols from almond hulls was significantly excellent when subcritical water extraction was performed under specific conditions.

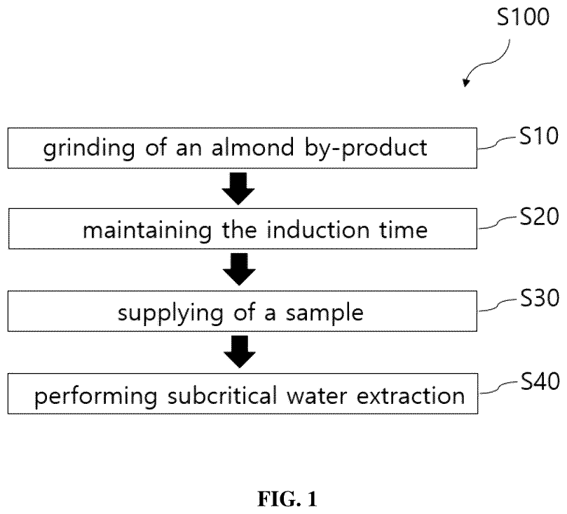

FIG. 1 shows a flow chart of a method for preparing a subcritical water extract of an almond by-product according to an example of the present disclosure. The method for preparing a subcritical water extract of an almond by-product is proceeded in the order of grinding an almond by-product (S10), maintaining the induction time (S20), supplying a sample (S30), and performing subcritical water extraction (S40).

Therefore, in an aspect, the present disclosure relates to a method for preparing a subcritical water extract of an almond by-product, grinding an almond by-product using a grinder; maintaining the induction time, which is the time required for the temperature of an oven inside a subcritical water extractor to become the same as the pre-set temperature of the subcritical water extractor; supplying the ground almond by-product to the subcritical water extractor; and supplying distilled water to the subcritical water extractor and performing subcritical water extraction at a temperature of 130° C. to 150° C. and a pressure of 8 MPa to 12 MPa.

In the present disclosure, the almond by-product, which is a by-product generated during the process of production and harvest of almonds, may include the hard almond shell called almond hulls, the inner skin surrounding the fruit, etc., and may preferably be almond hulls.

In the present disclosure, the term “subcritical water extraction” means a method of decomposing and extracting substances using ionized water under temperature and pressure conditions below the critical point of water (374° C., 22.1 MPa), and is called pressurized hot water extraction (PHWE) or pressurized low polarity water extraction (PLPW).

In the present disclosure, the step of grinding an almond by-product (S10) is a step of grinding an almond by-product into small pieces using a grinder, and specifically means grinding almond hulls into small pieces using a crusher. In the grinding step, the almond by-product may be ground using a grinder, a fine grinder, a blender, a mixer, a chopper, etc., but the device is not limited thereto.

In an embodiment of the present disclosure, in order to determine the particle size of almond hulls, experiments were conducted with five sieves (0.25 mm, 1.0 mm, 1.4 mm, 2.0 mm, and 2.8 mm), and it was confirmed that the final polyphenol content obtained was high when the particle size of almond hulls was 1.0 mm to 1.4 mm (Example 1). Therefore, it is preferable that the ground almond by-product have a particle size of 1.0 mm to 1.4 mm.

In the present disclosure, the term “induction time” refers to the time for the temperature of the oven inside a subcritical water extractor to become equal to the pre-set temperature of the subcritical water extractor, and the induction is performed before the step of subcritical water extraction.

Therefore, in the present disclosure, the step of maintaining the induction time (S20) is a step of maintaining the time so that the temperature of the oven inside a subcritical water extractor can be the same as the pre-set temperature of the subcritical water extractor. Since the rate of heating to the pre-set temperature of the subcritical water extractor increases in proportion to the heat capacity of the material inside a subcritical water extractor when the amount of a heat source supply is constant, and the induction time increases depending on the amount of the sample being transported into the subcritical water extractor. The induction time required is about 10 to 15 minutes based on the subcritical water extractor, and in an embodiment of the present disclosure, the induction time was maintained at 10 minutes.

In the present disclosure, the step of supplying a sample (S30) is a step of supplying a ground almond by-product to a subcritical water extractor, which is a preliminary step for the subcritical water extraction. The ground almond by-product may be supplied alone, but may be supplied after adding a step, in which a substance that does not participate in the subcritical water reaction (e.g., diatomaceous earth, silica, etc.) is added so as to increase the surface area of the ground almond by-product. In an embodiment of the present disclosure, in order to increase the surface area of the ground almond hulls, after mixing with diatomaceous earth, the resultant was supplied to the critical water extractor.

In the present disclosure, the step of performing subcritical water extraction (S40) is a step for extracting polyphenol from an almond by-product by presetting temperature and pressure, and after supplying distilled water as a solvent to a subcritical water extractor, subcritical water extraction is performed by setting temperature and pressure conditions. In particular, the extraction yield of polyphenols may vary depending on temperature and pressure conditions.

In the present disclosure, the subcritical water extraction may preferably be performed at a temperature of 130° C. to 150° C. When the subcritical water extraction temperature is below the above range, there is a problem in that the extraction yield of polyphenols decreases, whereas when the subcritical water extraction temperature exceeds the above range, there is a problem in that the thermal stability of polyphenols decreases thus altering the molecular structure of polyphenols.

Additionally, in the present disclosure, the subcritical water extraction may preferably be performed at a pressure of 8 MPa to 12 MPa, and more preferably at a pressure of 9 MPa to 11 MPa. When the subcritical water extraction pressure is below the above range, there is a problem in that the vaporization point is decreased thereby reducing the extraction yield of polyphenols, whereas when the vaporization point exceeds the above range, there is a problem in that the stability of the molecular structure of polyphenols decreases. In an embodiment of the present disclosure, the subcritical water extraction was performed at a pressure of 10 MPa.

Additionally, in the present disclosure, the subcritical water extraction may preferably be performed for 10 to 20 minutes. When the subcritical water extraction time is below the above range, there is a problem in that polyphenols may not be sufficiently extracted, whereas when the subcritical water extraction time exceeds the above range, there is a problem in that the stability of polyphenols decreases.

Hereinafter, the constitutions and effects of the present disclosure will be described in more detail through examples. However, these Examples are intended merely to illustrate the present disclosure and the scope of the present disclosure is not limited by these examples.

### EXPERIMENTAL METHOD

### 1. Pretreatment of Almond Hulls

Pre-dried almond hulls were ground in a blender, and the ground almond hulls were classified into 5 size types (less than 0.25 mm, 0.25 mm to 1 mm, 1 tmm to 1.4 mm, 1.4 mm to 2 mm, and 2 mm to 2.8 mm). Then, the ground almond hulls were evenly spread on a petri dish, dried at a temperature of 50° C. for 16 hours or more, placed in a glass bottle, and stored at room temperature (23° C. to 28° C.) away from air and direct sunlight.

### 2. Subcritical Water Extraction

1 g of previously pretreated ground almond hulls and 2 g of diatomaceous earth were uniformly mixed to prepare a sample of almond hulls, and then cut to size for a 22 mL stainless-steel extraction cell (23 mm i.d.×50 mm long, Dionex), and placed together with the prepared cellulose thimble filter (26 mm i.d.×60 mm long). In particular, two sheets of filter paper (Whatman 42 ashless) were placed on the bottom of the cell.

In particular, distilled water was used as a solvent, a glass bottle, where 2 L of distilled water was added, was installed in a subcritical water extractor (ASE 350, Dionex, Sunnyvale, CA, USA), and extraction was performed at each temperature condition (110° C., 130° C., 150° C., 170° C., and 190° C.) for each time period (5 min, 10 min, and 20 min). During the extraction, the pressure was fixed at about 10 MPa (⇄100 atm).

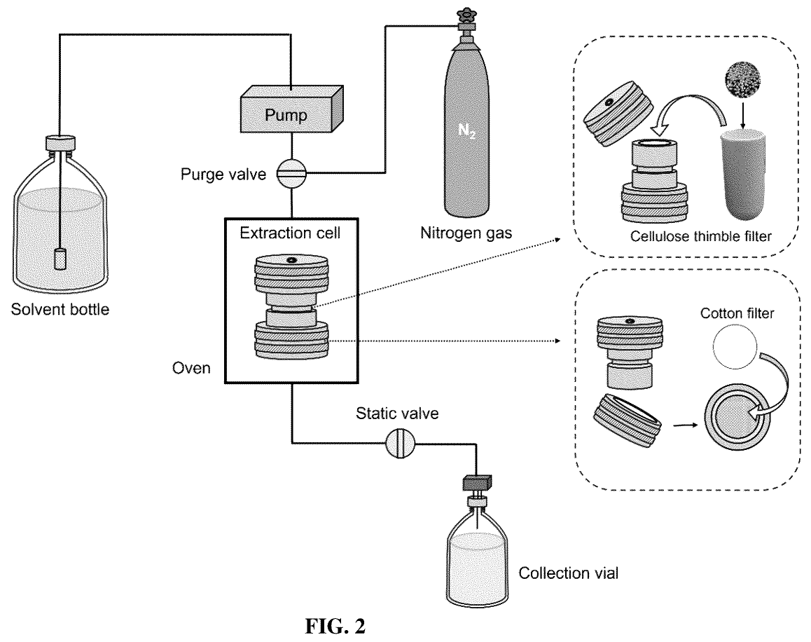

FIG. 2 is a schematic diagram of a subcritical water extractor, and the specific extraction procedure is as follows. The induction time is maintained to be 10 minutes so that the time required for the temperature of an oven inside a subcritical water extractor can be equal to the pre-set temperature of the subcritical water extractor. Then, a cell including almond hulls is loaded into the machine, and distilled water is pumped into the cell. Thereafter, the cell is pressurized and heated for a pre-set extraction time (Lee, et al., 2018).

After completion of the extraction, the extract was added into a collection vial along with nitrogen gas, centrifuged at 3,500 rpm for 25 minutes, and the total polyphenol content was measured using the supernatant. The remaining extract was stored in a refrigerator at 4° C.

### 3. Measurement of Total Polyphenol Content

The total polyphenol content was measured using the Folin-Ciocalteu method. Specifically, 2 mL of an aqueous solution of 2% sodium carbonate (Na₂CO₃) and 0.1 mL of an almond hull extract extracted using a subcritical water extractor were mixed. After vortexing for 3 minutes, 0.1 mL of 50% Folin-Ciocalto reagent was added to the mixture, and the mixture was vortexed again, wrapped in aluminum foil, and incubated in the dark at room temperature for 30 minutes. After 30 minutes, the absorbance was measured at 708 nm using a UV spectrophotometer, and a standard curve was created using gallic acid as a standard reagent. The total polyphenol content was calculated by substituting the result into the standard curve, and the whole process was repeated a total of 3 times.

### [Example 1] Determination of Particle Size of Almond Hulls

Five sieves with the respective hole size of 0.25 mm, 1.0 mm, 1.4 mm, 2.0 mm, and 2.8 mm were stacked in order with the sieve with the largest hole size at the top, and the ground almond hulls were poured onto the sieves and shaken to be classified. The particles filtered through each sieve were classified by size and stored at room temperature (23° C. to 28° C.).

Table 1 shows the measurement results of a polyphenol content according to the particle size of ground almond hulls. In order to determine the particle size with the highest extraction efficiency, polyphenols were extracted by setting the conditions for subcritical water extraction as 130° C., 150° C., and 170° C. for 5 minutes. The unit of the polyphenol content is mg GAE/g dw, which indicates gallic acid equivalent (GAE) per gram of dry weight (dw) of almond hulls.

TABLE 1
(Unit: mg GA/g dw)

| | Particle sizes | | | | |
|---|---|---|---|---|---|
| | | 0.25- | 1.0- | 1.4- | 2.0- |
| Condition | <0.25 mm | 1.0 mm | 1.4 mm | 2.0 mm | 2.8 mm |
| 130° C., | 60.79 ± | 77.56 ± | 77.78 ± | 65.12 ± | 53.83 ± |
| 5 min | 11.22 | 5.45 | 0.65 | 6.38 | 2.45 |
| 150° C., | 49.63 ± | 94.14 ± | 93.95 ± | 78.27 ± | 65.76 ± |
| 5 min | 4.49^{a} | 7.27^{c} | 3.37^{c} | 3.07^{bc} | 1.62^{b} |
| 170° C., | 98.30 ± | 86.20 ± | 81.58 ± | 88.71 ± | 75.34 ± |
| 5 min | 0.43 | 22.48 | 2.78 | 6.38 | 6.03 |

As a result, particles with a size of 1.0 mm to 1.4 mm which showed a high total polyphenol content and a low standard deviation at each temperature condition were finally selected.

### [Example 2] Measurement of Total Polyphenol Content in Almond Hulls According to Extraction Temperature and Extraction Time

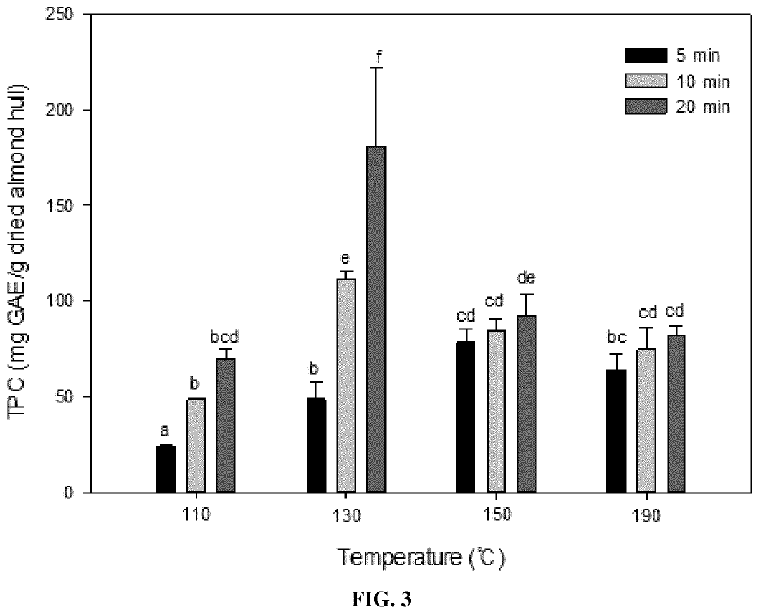

Table 2 and FIG. 3 show the measurement results of the total polyphenol content in almond hulls according to extraction temperature and extraction time conditions (unit: mg GAE/g dw).

TABLE 2

| | |
|---|---|
| Extraction | Extraction Temperature |

| | | | | |
|---|---|---|---|---|
| Time | 110° C. | 130° C. | 150° C. | 190° C. |

| | | | | | |
|---|---|---|---|---|---|
| 5 | min | 23.68 ± | 48.74 ± | 78.1 ± | 63.64 ± |
| | | 1.38^{a} | 8.54^{b} | 7.54^{cd} | 9.03^{bc} |
| 10 | min | 48.56 ± | 111.46 ± | 84.32 ± | 74.79 ± |
| | | 0.18^{b} | 4.59^{e} | 6.4^{cd} | 11.68^{cd} |
| 20 | min | 70.04 ± | 181.11 ± | 92.36 ± | 82.33 ± |
| | | 4.63^{bcd} | 41.03^{f} | 11.57^{de} | 5.09^{cd} |

As a result, upon review of Table 2 and FIG. 3, it can be confirmed that when the extraction time is 5 minutes, the polyphenol content is low, whereas when the extraction time is 10 to 20 minutes, the polyphenol content is generally high. In addition, it can be confirmed that even when the extraction time was 10 to 20 minutes, if the extraction temperature was as low as 110° C., the polyphenol content was about 70 mg GAE/g or less, whereas when the extraction temperature was between 130° C. and 150° C., the total polyphenol content in almond hulls was as high as to have a maximum value of about 181 mg GAE/g.

Although the present disclosure has been described with reference to the examples, which are merely exemplary, those skilled in the art to which the present disclosure pertains will be able to understand that various modifications and equivalent other examples are possible. Therefore, the disclosed examples should be considered from an illustrative aspect rather than a restrictive aspect, and the true technical protection scope of the present disclosure should be determined by the technical idea of the claims.

### DETAILED DESCRIPTION OF MAIN ELEMENTS

S100: a method for preparing a subcritical water extract of an almond by-product
S10: grinding of an almond by-product
S20: maintaining the induction time
S30: supplying of a sample
S40: performing subcritical water extraction

What is claimed is:

1. A method for preparing a subcritical water extract of an almond by-product, comprising:
grinding an almond by-product using a grinder;
maintaining the induction time, which is the time required for the temperature of an oven inside a subcritical water extractor to become the same as the pre-set temperature of the subcritical water extractor;
supplying the ground almond by-product to the subcritical water extractor; and
supplying distilled water to the subcritical water extractor and performing subcritical water extraction at a temperature of 130° C. to 150° C. and a pressure of 8 MPa to 12 MPa.

2. The method of claim 1, wherein the subcritical water extraction is performed for 10 to 20 minutes.

3. The method of claim 1, wherein the almond by-product is almond hulls.

4. The method of claim 1, wherein the ground almond by-product has a particle size of 1.0 mm to 1.4 mm.

5. The method of claim 1, wherein the subcritical water extract of the almond by-product comprises polyphenols.
